(19) United States
(12) Patent Application Publication
(10) Pub. No.: US 2007/0153504 A1
(43) Pub. Date: Jul. 5, 2007

(54) Floating water activated flashlight

(75) Inventor: David C. Thornhill, Wichita, KS (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: The Coleman Company, Inc., Wichita, KS (US)

(21) Appl. No.: 11/325,911

(22) Filed: Jan. 4, 2006

(51) Int. Cl. F21L 4/00

(52) U.S. Cl. 362/157

(57) ABSTRACT

A flashlight that includes contacts that close a circuit when the flashlight is in water. The closed circuit provides a connection between batteries and a lamp, lighting the lamp. The flashlight is sealed so that it floats when dropped in the water.

### TECHNICAL FIELD OF THE INVENTION

The present invention is directed to lights, and more particularly to flashlights.

### BACKGROUND OF THE INVENTION

In general, a flashlight is a portable electric light, such as a luminaire configured to be held by a user. Flashlights are useful for a variety of different applications, including use for light in the outdoors, backup lighting in a power outage, or as a source of light to find an object in a dark location.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a flashlight is provided. The flashlight includes contacts that close a circuit when the flashlight is in water. The closed circuit provides a connection between batteries and a lamp, lighting the lamp. The flashlight is sealed so that it floats when dropped in the water.

Other features of the invention will become apparent from the following detailed description when taken in conjunction with the drawings, in which:

### BRIEF DESCRIPTION OF THE DRAWINGS

FIG. 1 shows a side perspective view of a flashlight in accordance with an embodiment, with the flashlight shown floating in water;

FIG. 2 shows a cutaway view of the flashlight of FIG. 1; and

FIG. 3 shows a circuit that may be used for the flashlight of FIG. 1.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

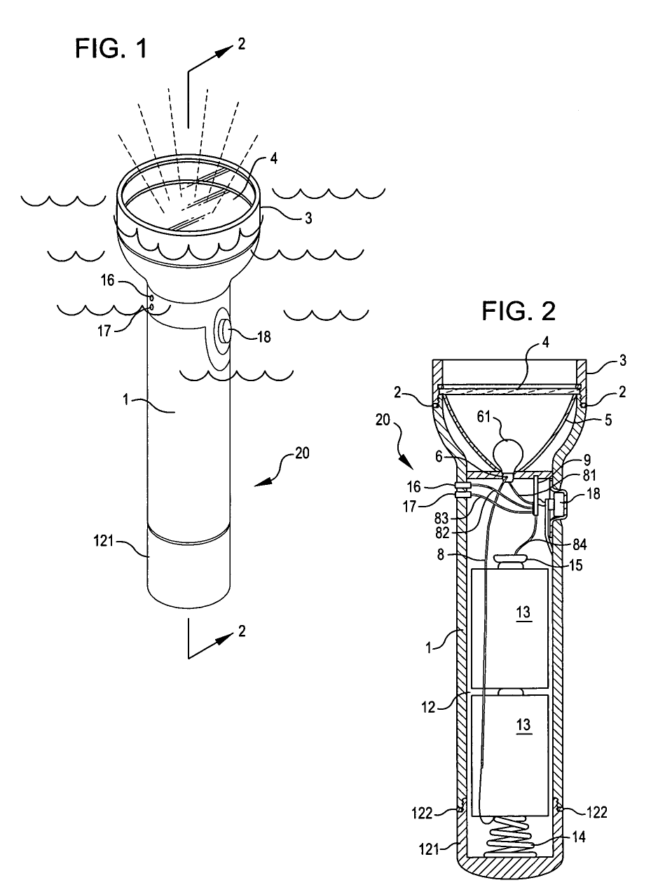

Referring now to the drawings, in which like reference numerals represent like parts throughout the several views, FIG. 1 shows a flashlight 20 in accordance with an embodiment of the invention. The flashlight 20 includes a housing 1 having a waterproof seal 2 (FIG. 2), such as an O-ring, at an upward portion. The O-ring 2 forms a seal between the housing 1 and a lamp cover 3. A lens 4 extends across the lamp cover 3, and a reflector 5 is mounted behind the lens and within the lamp cover. A bulb 61 having a bulb base 6 is mounted in the reflector 5. Although a bulb 61 is shown, the flashlight may include any form of lamp, including a light emitting diode (LED), an incandescent lamp, a fluorescent lamp, or other lamps or lights.

The flashlight 20 includes batteries 13 mounted in a battery box 12 defined by an interior of the housing 1. The housing 1 includes a bottom cap 121 for providing access to the interior of the battery box 12 to replace the batteries 13. The bottom cap 121 includes an O-ring 122 or another seal to form a watertight connection between the bottom cap 121 and the housing 1. As an alternate to batteries 13, a rechargeable battery or batteries may be used within the flashlight 20.

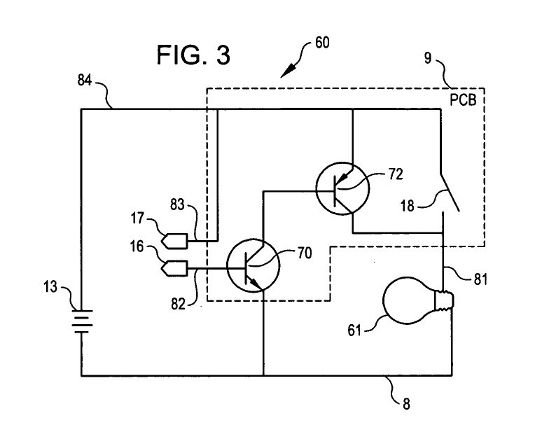

The battery box 12 includes a negative spring 14 and a positive contact 15 for contacting the negative and positive terminals of the batteries 13, respectively. A wire or cable 8 (FIG. 3) extends from the negative spring 14 to a first terminal of the bulb 61. An additional wire 81 extends from a second terminal of the bulb 61 to a printed circuit board 9. A third wire 82 extends from the printed circuit board 9 to a first current conductor 16 that extends outside of the housing 1. A fourth wire 83 extends from the printed circuit board 9 to a second current conductor 17, which also extends outside the housing 1. A fifth wire 84 extends between the positive contact 15 and the printed circuit board 9. A manual switch 18 is provided and is connected to the printed circuit board 9. The switch includes a watertight seal in a manner known in the art.

In the embodiment shown, the flashlight 20 floats. That is, the flashlight 20 stays at a top surface of a body of water, even if only a slight portion or none of the flashlight extends above a surface of the water. The floatation provided may be sufficient only to make the flashlight buoyant. To this end, the flashlight 20 is preferably sized so that the air pocket formed within the flashlight, for example behind the reflector 5, is sufficient to support the flashlight 20 along with the batteries 13, when the flashlight 20 is accidentally dropped in water. For the flashlight 20 shown in the drawings, a larger head portion is provided for this function, although air pockets may be formed at any location so as to provide this function. The size of an air pocket needed to float a flashlight may be determined empirically or by experimentation. In addition, the flashlight may be floatable in other ways, for example by the addition of Styrofoam or other buoyant materials.

FIG. 1 shows the exterior of the flashlight 20, and is helpful in showing that the first current conductor 16 and the second current conductor 17 are exposed on the exterior of the flashlight. These current conductors 16, 17 are positioned so that they are in contact with water when the flashlight 20 is floating, regardless of the orientation of the flashlight. In the embodiment shown in the drawings, as can be seen in FIG. 2, the flashlight is mostly submerged when floating at a surface S of the water. Because the flashlight 20 is only slightly buoyant, the head of the flashlight sticks only slightly above the surface S of the water. The current conductors 16, 17 are positioned at a juncture of the head of the flashlight 20 and the housing 1, and thus are positioned below the water.

Although the head of the flashlight 20 is shown at the surface S of the water, a flashlight may be configured in a different manner so that a different portion is presented at the surface. As an example, a flashlight may float on its side or upside down.

FIG. 3 shows a circuit 60 that may be used with the flashlight 20 or 50 in accordance with an embodiment. As can be seen, the manual switch 18 may be used to close the circuit with the batteries 13 to turn on the bulb 61. Alternatively, an electrical connection may be provided between the first and second current conductors 16, 17. This connection may be provided, for example, when the flashlight 20 is dropped in water. Water acts as a conductor between the two current conductors 16, 17, and thus a signal is supplied to a transistor 70. This transistor in turn provides a signal to a second transistor 72, which closes the circuit between the batteries 13 and the bulb 61, turning on the bulb.

As can be understood, the flashlight 20 the present invention is very useful when dropped in water. Not only does the flashlight 20 float, but, if the flashlight 20 is not already turned on, the bulb 61 turns on as a result of water arcing across the contacts 16, 17. Thus., the flashlight is easy to recover after being dropped in the water.

Although the flashlight 20 is of conventional form, embodiments of the invention may be used on other flashlight designs. In addition, the concepts of the present invention may be applied to any lighting appliance, including an electric lantern. In such an embodiment, the lantern body is sealed for floating, and includes contacts that light the lantern when the lantern is in water.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A flashlight, comprising:
a watertight housing;
a power supply mounted in the housing;
a lamp mounted to the housing;
water contacts on the housing;
a circuit configured to turn on the lamp when the contacts come in contact with water;
a manual switch connected to the circuit, the circuit configured to turn on the lamp when the manual switch is activated; and
wherein the watertight housing is sized and shaped so that the flashlight floats on water.

2. The flashlight of claim 1, wherein the power supply is one or more batteries.

3. The flashlight of claim 1, further comprising a head portion, and wherein the head portion is sufficiently large so that the flashlight floats from the head.

4. The flashlight of claim 1, wherein the lamp comprises a member of the set of a light emitting diode, an incandescent lamp, and a fluorescent lamp.

5. A flashlight, comprising:
a power supply;
a circuit connected to the power supply;
a lamp connected to the circuit;
a manual switch and water contacts connected to the circuit, the circuit being configured to provide power to and turn on the lamp when the contacts come in contact with water or when the manual switch is activated; and
means for floating the flashlight.

6. The flashlight of claim 5, wherein the power supply is one or more batteries.

7. The flashlight of claim 5, wherein said means for floating comprises a watertight head portion sufficiently large so that the flashlight floats from the head.

8. The flashlight of claim 5, wherein the lamp comprises a member of the set of a light emitting diode, an incandescent lamp, and a fluorescent lamp.

9. The flashlight of claim 5, wherein said means for floating comprises buoyant material.

10. A flashlight that floats on water and that automatically turns on a light beam as a result of the flashlight being in water, the flashlight including a switch configured to turn on the light beam by manually activating the switch.

11. A light, comprising:
a watertight housing;
a power supply mounted in the housing;
a lamp mounted to the housing;
water contacts on the housing;
a circuit configured to turn on the lamp when the contacts come in contact with water;
a manual switch connected to the circuit, the circuit configured to turn on the lamp when the manual switch is activated; and
wherein the watertight housing is sized and shaped so that the light floats on water.

12. The light of claim 11, wherein the power supply is one or more batteries.

13. The light of claim 11, wherein the light is a lantern.

14. The light of claim 11, wherein the lamp comprises a member of the set of a light emitting diode, an incandescent lamp, and a fluorescent lamp.

15. A light, comprising:
a power supply;
a circuit connected to the power supply;
a lamp connected to the circuit;
a manual switch connected to the circuit;
water contacts connected to the circuit, the circuit being configured to provide power to and turn on the lamp when the contacts come in contact with water or when the manual switch is activated; and
means for floating the light.

16. The light of claim 15, wherein the power supply is one or more batteries.

17. The light of claim 15, wherein said means for floating comprises a watertight body sufficiently large so that the light floats.

18. The light of claim 15, wherein the lamp comprises a member of the set of a light emitting diode, an incandescent lamp, and a fluorescent lamp.

19. The light of claim 15, wherein said means for floating comprises buoyant material.

20. The light of claim 15, wherein the light is a lantern.
